(19) United States
(12) Patent Application Publication
(10) Pub. No.: US 2026/0221042 A1
(43) Pub. Date: Jul. 30, 2026

(54) SYSTEMS AND METHODS FOR DATA ENTRY DURING FLIGHT OF AN AIRCRAFT

(71) Applicant: HONEYWELL INTERNATIONAL INC., Charlotte, NC (US)

(72) Inventors: Gobinathan Baladhandapani, Madurai (IN); Ari Narayanan M, Madurai (IN); Karthikeyan M, Madurai (IN)

(73) Assignee: HONEYWELL INTERNATIONAL INC., Charlotte, NC (US)

(21) Appl. No.: 19/074,564

(22) Filed: Mar. 10, 2025

(30) Foreign Application Priority Data
Jan. 24, 2025 (IN) 202511005954

(51) Int. Cl. G08G 5/23; G06F 40/205; G08G 5/21; G08G 5/24; G08G 5/26; G08G 5/76

(52) U.S. Cl. CPC G08G 5/23; G06F 40/205; G08G 5/21; G08G 5/24; G08G 5/26; G08G 5/76

(57) ABSTRACT

Systems and methods are provided for promoting accurate data entry into flight systems during flight of an aircraft. The systems include a communication system configured to receive external information including user enterable information from at least one external source separate from the aircraft, an audio system configured to broadcast audible messages, and a controller configured to, by one or more processors, extract the user enterable information from the external information, generate and store expected data indicative of the user enterable information and an association with one or more avionics through which a user is able to input the user enterable information, detect a user interface interaction wherein the user is inputting information via the one or more avionics, and read aloud, via the audio system, the user enterable information in response to detecting the user interface interaction.

### CROSS REFERENCE TO RELATED APPLICATION

This application claims priority to India Provisional Patent Application No. 202511005954, filed January 24, 2025, the entire content of which is incorporated by reference herein.

### TECHNICAL FIELD

The present invention generally relates to aircraft onboard systems, and more particularly relates to systems and methods for promoting accurate data entry into flight systems of an aircraft during flight.

### BACKGROUND

Communications may be received by an aircraft during the flight thereof that lead to a pilot changing parameters of a flight system. For example, an aircraft may receive a clearance issued by Air Traffic Control (ATC) that permits the aircraft to proceed under specific conditions within a controlled airspace. The pilot of the aircraft may then choose to adjust flight systems of the aircraft based on the specific conditions received, such as adjusting an altitude of the aircraft.

Accurate input of these data entries may be critical to safe operation of the aircraft. However, certain atmospheric conditions, such as turbulence, may present challenges for pilots during data entry. For example, turbulence may result in difficultly for a pilot when reading textual data from cockpit displays, when selecting objects presented on a display, and the like. These challenges may result in an increase in workload for the pilot.

Hence, there is a need for systems and methods that promote accurate and efficient data entry, especially during turbulence. Furthermore, other desirable features and characteristics of the present invention will become apparent from the subsequent detailed description and the appended claims, taken in conjunction with the accompanying drawings and the foregoing technical field and background.

This summary is provided to describe select concepts in a simplified form that are further described in the Detailed Description. This summary is not intended to identify key or essential features of the claimed subject matter, nor is it intended to be used as an aid in determining the scope of the claimed subject matter.

In various examples, a method is provided that includes receiving, with a communication system onboard an aircraft, external information including user enterable information from at least one external source separate from the aircraft, extracting, with one or more processors of a controller of the aircraft, the user enterable information from the external information, generating and storing, with the controller, expected data indicative of the user enterable information and an association with one or more avionics through which a user is able to input the user enterable information, detecting, with the controller, a user interface interaction wherein the user is inputting information via the one or more avionics, and reading aloud, with an audio system of the aircraft, the user enterable information in response to detecting the user interface interaction.

In various examples, a system is provided onboard an aircraft. The system includes a communication system configured to receive external information including user enterable information from at least one external source separate from the aircraft, an audio system configured to broadcast audible messages, and a controller in operable communication with the communication system and the audio system. The controller is configured to, by one or more processors, extract the user enterable information from the external information, generate and store expected data indicative of the user enterable information and an association with one or more avionics through which a user is able to input the user enterable information, detect a user interface interaction wherein the user is inputting information via the one or more avionics, and read aloud, via the audio system, the user enterable information in response to detecting the user interface interaction.

In various examples, an aircraft is provided that includes a communication system configured to receive external information including user enterable information from at least one external source separate from the aircraft, an audio system configured to broadcast audible messages; and a controller in operable communication with the communication system and the audio system. The controller is configured to, by one or more processors, extract the user enterable information from the external information, generate and store expected data indicative of the user enterable information and an association with one or more avionics through which a user is able to input the user enterable information, monitor for turbulence during flight of the aircraft, activate a turbulence assistance mode in response to detecting the turbulence, and deactivate the turbulence assistance mode in response to detecting that the turbulence has ended or have been avoided. While the turbulence assistance mode is active the controller is configured to, by the one or more processors, detect a user interface interaction wherein the user is inputting information via the one or more avionics, and read aloud, via the audio system, the user enterable information in response to detecting the user interface interaction.

Furthermore, other desirable features and characteristics of the method, system, and aircraft will become apparent from the subsequent detailed description and the appended claims, taken in conjunction with the accompanying drawings and the preceding background.

### BRIEF DESCRIPTION OF DRAWINGS

The present disclosure will hereinafter be described in conjunction with the following drawing figures, wherein like numerals denote like elements, and wherein:

FIG. 1 schematically represents a mobile platform and components of a turbulence assistance system thereof in accordance with an embodiment;

FIG. 2 is a dataflow diagram illustrating operation of the turbulence assistance system of FIG. 1 in accordance with an embodiment;

FIG. 3 is a flowchart illustrating an exemplary method for reading out expected information while a user is inputting flight system information in accordance with an embodiment;

FIG. 4 is a flowchart illustrating an exemplary method for promoting data entry prior to turbulent conditions in accordance with an embodiment;

FIG. 5 is a flowchart illustrating an exemplary method for reading text aloud on demand in accordance with an embodiment;

FIG. 6 is a flowchart illustrating an exemplary method for cross-checking user entered information with expected information in accordance with an embodiment; and

FIG. 7 is a portion of an exemplary data lookup table with entries generated and stored in response to an aircraft receiving a clearance in accordance with an embodiment.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

Systems and methods disclosed herein provide for data entry assistance to pilots onboard a mobile platform. The systems and methods may be particularly beneficial when the aircraft is experiencing turbulent conditions, during which it may be challenging for a pilot to read and enter information into flight systems. The systems and methods disclosed herein provide for determining expected data entries, and generating audible messages to read aloud the expected data entries at times that are relevant to the specific expected data. In some examples, the systems and methods may directly assist the pilot with the data entry by suggesting the expected data.

The mobile platform may be any type of vehicle, such as but not limited to various types of aircraft. It should be noted that the term aircraft, as utilized herein, may include any manned or unmanned object capable of flight. Examples of aircraft may include, but are not limited to, fixed-wing aerial vehicles (e.g., propeller-powered or jet powered), rotary-wing aerial vehicles (e.g., helicopters), manned aircraft, unmanned aircraft (e.g., unmanned aerial vehicles, or UAVs), delivery drones, etc. For convenience, the systems and methods will be described in reference to a manned airplane; however, as noted the systems and methods are not limited to such application.

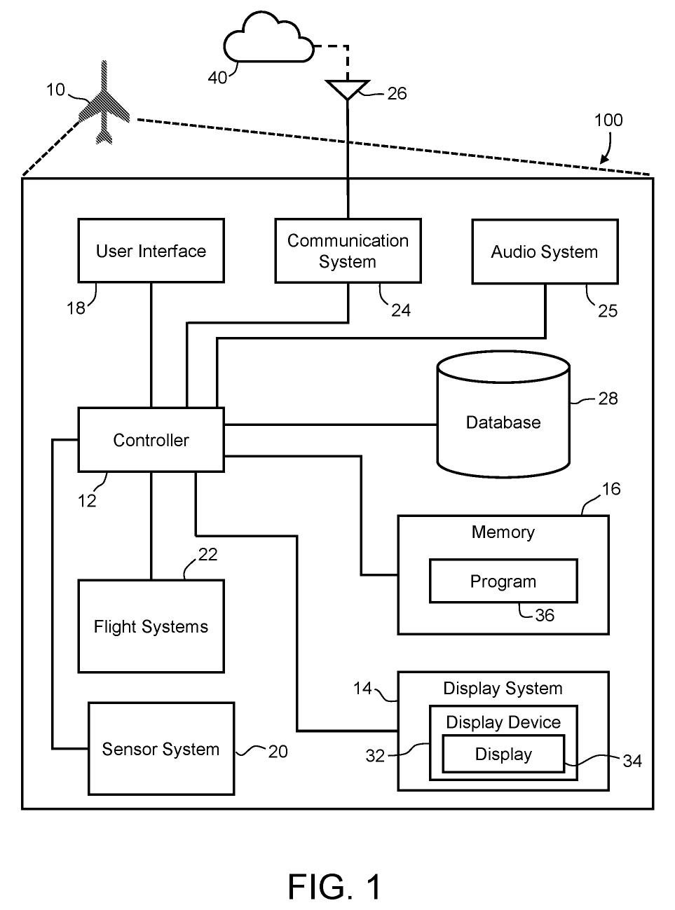

Referring now to FIG. 1, an aircraft 10, in this example an airplane, and certain systems thereof are illustrated in accordance with an exemplary and non-limiting embodiment of the present disclosure. A turbulence assistance system 100 may be utilized onboard the aircraft 10 as described herein. As schematically depicted in FIG. 1, the system 100 includes and/or is functionally coupled to the following components or subsystems, each of which may assume the form of a single device or multiple interconnected devices, including, but not limited to, a controller 12 operationally coupled to: at least one display device 32, which may optionally be part of a larger onboard display system 14; computer-readable storage media or memory 16; a user interface 18, which may optionally be part of the display system 14, an onboard sensor system 20 including, for example, an array of geospatial and flight parameter sensors, various flight systems 22, a communication system 24, an audio system 25, and one or more databases 28.

Although schematically illustrated in FIG. 1 as a single unit, the individual elements and components of the system 100 can be implemented in a distributed manner utilizing any practical number of physically distinct and operatively interconnected pieces of hardware or equipment. When the system 100 is utilized as described herein, the various components of the system 100 will typically all be located onboard the aircraft 10.

The term “controller,” as appearing herein, broadly encompasses those components utilized to carry-out or otherwise support the processing functionalities of the system 100. Accordingly, the controller 12 can encompass or may be associated with any number of individual processors, flight control computers, navigational equipment pieces, computer-readable memories (including or in addition to the memory 16), power supplies, storage devices, interface cards, and other standardized components.

In various embodiments, the controller 12 includes at least one processor, a communication bus, and a computer readable storage device or media. The processor performs the computation and control functions of the controller 12. The processor can be any custom made or commercially available processor, a central processing unit (CPU), a graphics processing unit (GPU), an auxiliary processor among several processors associated with the controller 12, a semiconductor-based microprocessor (in the form of a microchip or chip set), any combination thereof, or generally any device for executing instructions. The computer readable storage device or media may include volatile and nonvolatile storage in read-only memory (ROM), random-access memory (RAM), and keep-alive memory (KAM), for example. The computer-readable storage device or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 12. The bus serves to transmit programs, data, status and other information or signals between the various components of the aircraft 10. The bus can be any suitable physical or logical means of connecting computer systems and components. This includes, but is not limited to, direct hard-wired connections, fiber optics, infrared, and wireless bus technologies.

The instructions may include one or more separate programs, each of which comprises an ordered listing of executable instructions for implementing logical functions. The instructions, when executed by the processor, receive and process signals from the sensor system 20, perform logic, calculations, methods and/or algorithms, and generate data based on the logic, calculations, methods, and/or algorithms. Although only one controller 12 is shown in FIG. 1, embodiments of the aircraft 10 can include any number of controllers 12 that communicate over any suitable communication medium or a combination of communication mediums and that cooperate to process the sensor signals, perform logic, calculations, methods, and/or algorithms, and generate data. In various embodiments, the controller 12 includes or cooperates with at least one firmware and software program (generally, computer-readable instructions that embody an algorithm) for carrying-out the various process tasks, calculations, and control/display functions described herein. During operation, the controller 12 may be programmed with and execute at least one firmware or software program, for example, a program 36, that embodies one or more algorithms, to thereby perform the various process steps, tasks, calculations, and control/display functions described herein.

The controller 12 may exchange data with one or more external sources 40 to support operation of the system 100 in various embodiments. In this case, bidirectional wireless data exchange may occur via the communication system 24 over a communications network, such as a public or private network implemented in accordance with Transmission Control Protocol/Internet Protocol architectures or other conventional protocol standards. Encryption and mutual authentication techniques may be applied, as appropriate, to ensure data security.

In various embodiments, the communication system 24 may be configured to support instantaneous (i.e., real time or current) communications between on-board systems, the controller 12, and one or more external sources 40 physically and/or geographically remote to the system 100 and/or the aircraft 10. The communication system 24 may incorporate various components configured to wirelessly transmit data to and receive data from the external sources 40, such as one or more antennas 26, transmitters, receivers, and the supporting communications hardware and software required for components of the system 100 to communicate as described herein. In various embodiments, the communication system 24 may have additional communications not directly relied upon herein, such as bidirectional pilot-to-ATC (air traffic control) communications via a datalink, and any other suitable radio communication system that supports communications between the aircraft 10 and various external source(s).

The memory 16 can encompass any number and type of storage media suitable for storing computer-readable code or instructions, such as the program 36, as well as other data generally supporting the operation of the system 100. As can be appreciated, the memory 16 may be part of the controller 12, separate from the controller 12, or part of the controller 12 and part of a separate system. The memory 16 can be any suitable type of storage apparatus, including various different types of direct access storage and/or other memory devices.

A source of information suitable for operating one or more systems of the aircraft 10 may be part of the system 100. In certain embodiments, the source may be the databases 28 employed to receive and store flight system related data, such as user enterable data, which may be updated on a periodic or iterative basis to ensure data timeliness. In various embodiments, the user enterable data may include various types of information that may be input, for example, into one of the flight systems 22, by a pilot or flight crew during a flight of the aircraft 10, such as adjustments to altitude. In various embodiments, these databases 28 may be available online and accessible remotely by a suitable wireless communication system, such as the communication system 24.

The sensor system 20 may sense various observable conditions internal or external to the aircraft 10, and supply various types of data and/or measurements to the controller 12. In various embodiments, the sensor system 20 may supply, without limitation, one or more of: inertial reference system measurements providing a location, Flight Path Angle (FPA) measurements, airspeed data, groundspeed data, vertical speed data, vertical acceleration data, altitude data, attitude data including pitch and roll measurements, yaw data, data related to ownship weight, time/date information, heading information, data related to atmospheric conditions (including turbulence), flight path data, flight track data, radar altitude data, geometric altitude data, wind speed and direction data. Further, in certain embodiments of the system 100, the controller 12, and the other components of the system 100 may be included within or cooperate with any number and type of systems commonly deployed onboard aircraft including, for example, an FMS, an Attitude Heading Reference System (AHRS), an Instrument Landing System (ILS), and/or an Inertial Reference System (IRS).

With continued reference to FIG. 1, the display device 32 can include any number and type of image generating devices on which one or more avionic displays 34 may be produced. In various embodiments, the display device 32 may be affixed to the static structure of the aircraft 10 cockpit as, for example, a Head Down Display (HDD) or Head Up Display (HUD) unit. Alternatively, the display device 32 may assume the form of a movable display device (e.g., a pilot-worn display device) or a portable display device, such as an Electronic Flight Bag (EFB), a laptop, or a tablet computer carried into the aircraft 10 cockpit by a pilot.

At least one avionic display 34 may be generated on display device 32 during operation of the system 100. The term “avionic display” as used herein is synonymous with the terms “aircraft-related display” and “cockpit display” and encompasses displays generated in textual, graphical, cartographical, and other formats. The system 100 can generate various types of lateral and vertical avionic displays 34 on which symbology, text annunciations, and other graphics pertaining to flight planning are presented for a pilot to view. The display device 32 may be configured to continuously render at least one avionic display 34 showing, as examples, a terrain environment at a current location of the aircraft 10, operating parameters of the aircraft 10, flight plan parameters, etc. The avionic display 34 generated and controlled by the system 100 can include alphanumerical input displays of the type commonly presented on the screens of multi-function control and display units (MCDUs), as well as Control Display Units (CDUs) generally. Specifically, certain embodiments of the avionic displays 34 include one or more two dimensional (2D) avionic displays, such as a horizontal (i.e., lateral) navigation display or vertical navigation display; and/or on one or more three dimensional (3D) avionic displays, such as a Primary Flight Display (PFD) or an exocentric 3D avionic display.

The user interface 18 may include one or more human-machine interfaces, such as knobs, switches, keyboards, selection devices, etc. that provide for entering user input, such as the user enterable data. In various embodiments, the user interface 18 may be a touch screen display, optionally implemented as an integration of the user interface 18 and the display device 32. Via various display and graphics systems processes, the controller 12 may command and control the touch screen display generating a variety of graphical user interface (GUI) objects or elements, for example, buttons, sliders, and the like, which are used to prompt a user to interact with the human-machine interface to provide user input, and to activate respective functions and provide user feedback, responsive to received user input at the GUI element.

The audio system 25 may include various components configured to generate and produce audible messages to the pilot or flight crew, and optionally record voice commands. For example, the audio system 25 may include one or more speakers, headphones, or the like for audio broadcasting, playback, etc., microphones for voice transmission, audio amplifiers, push-to-talk switches or controls, and noise-canceling systems. In some examples, the audio system 25 may be integrated into a central warning system of the aircraft 10 to provide audio warnings and notifications for system failures, altitude deviations, or other critical alerts.

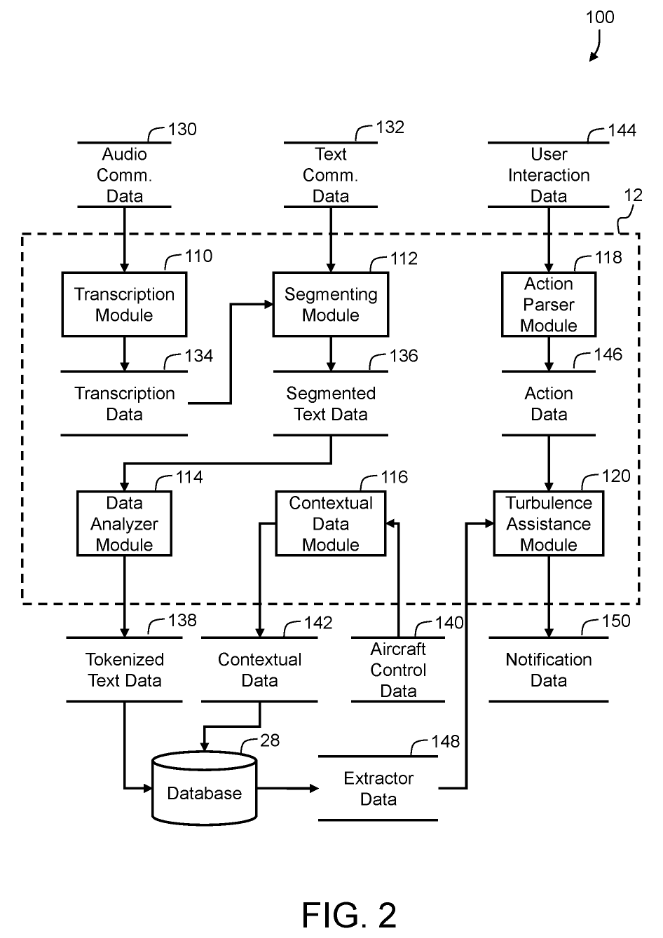

With reference to FIG. 2 and with continued reference to FIG. 1, a dataflow diagram illustrates elements of the system 100 of FIG. 1 in accordance with various embodiments. As can be appreciated, various embodiments of the system 100 according to the present disclosure may include any number of modules, for example, embedded within the controller 12, which may be combined and/or further partitioned to similarly implement systems and methods described herein. Furthermore, inputs to the system 100 may be received from other control modules (not shown) associated with the aircraft 10, and/or determined/modeled by other sub-modules (not shown). Furthermore, the inputs might also be subjected to preprocessing, such as sub-sampling, noise-reduction, normalization, feature-extraction, missing data reduction, and the like. In various embodiments, the system 100 includes a transcription module 110, a segmenting module 112, a data analyzer module 114, a contextual data module 116, an action parser module 118, and a turbulence assistance module 120.

In various embodiments, the transcription module 110 receives as input audio communication data 130 that includes recordings of audible messages received by the communication system 24. The transcription module 110 may use various techniques, such as speech-to-text conversion, to convert the recordings to text. The transcription module 110 generates transcription data 134 that includes the text converted from the recordings.

In various embodiments, the segmenting module 112 receives as input text communication data 132 that includes digital data including text-based messages received by the communication system 24. The segmenting module 112 may use keyword spotter techniques, sentence segmentation techniques, etc. to identify and extract user enterable information from the text communication data 132. The segmenting module 112 generates segmented text data 136 that includes the user enterable information as isolated text.

In various embodiments, the data analyzer module 114 receives as input the segmented text data 136 generated by the segmenting module 112. The data analyzer module 114 may use various techniques such as semantic, intent, and/or data analysis techniques to associate the user enterable information with one or more of the flight systems 22 and/or avionics for inputting information into the flight systems 22. In some examples, the flight systems 22 may include a flight management system (FMS), a flight controller (FC), a traffic collision avoidance system (TCAS), a weather system, a communication system, a fuel system, an engine system, an electronics system, a hydraulics system, or another system that may affect the operation of the aircraft 10. The data analyzer module 114 generates tokenized text data 138 that includes the user enterable information linked with its corresponding flight system 22 and/or avionic. The data analyzer module 114 may store the tokenized text data 138 in the database 28.

In various embodiments, the contextual data module 116 receives as input aircraft control data 140 indicative of available cockpit controls or avionics that allow for user input, for example, as indicated by a standard operating procedure or a predetermined checklist. The contextual data module 116 generates contextual data 142 indicative of the various avionics and the types of information enterable therewith. The contextual data module 116 may store the contextual data 142 in the database 28 for use in linking expected user enterable information with the corresponding avionics. In some examples, the contextual data 142 may be retrievable or accessible by the data analyzer module 114 for associating and/or linking the user enterable information with one or more of the flight systems 22 and/or avionics.

In various embodiments, the action parser module 118 receives as input user interaction data 144 indicating that a user is currently or actively inputting information into one of the flight systems 22 via the user interface 18. For example, the user interaction data 144 may indicate that a user is currently rotating a knob, typing an entry into a widget, or preparing to select a line select key from a menu on a display (e.g., the avionic display 34). The action parser module 118 processes the user interaction data 144 and generates action data 146 indicative of the identified user action. As used herein, a user action intended to input the user enterable information into one of the flight systems 22 via the user interface 18 is referred to as a user interface interaction.

In various embodiments, the turbulence assistance module 120 receives as input the action data 146 generated by the action parser module 118. The turbulence assistance module 120 may retrieve expected data 148 from the database 28 that is indicative of the tokenized text data 138 and the contextual data 142. In this manner, the turbulence assistance module 120 may check the database 28 for expected information associated with the user action identified in the action data 146. The turbulence assistance module 120 generates notification data 150 configured to cause the expected information to be broadcast (i.e., read aloud) by the audio system 25 while the user is inputting the information. In this manner, the user is able to hear the expected information while simultaneously entering the information thereby allowing for cross-checking in real time.

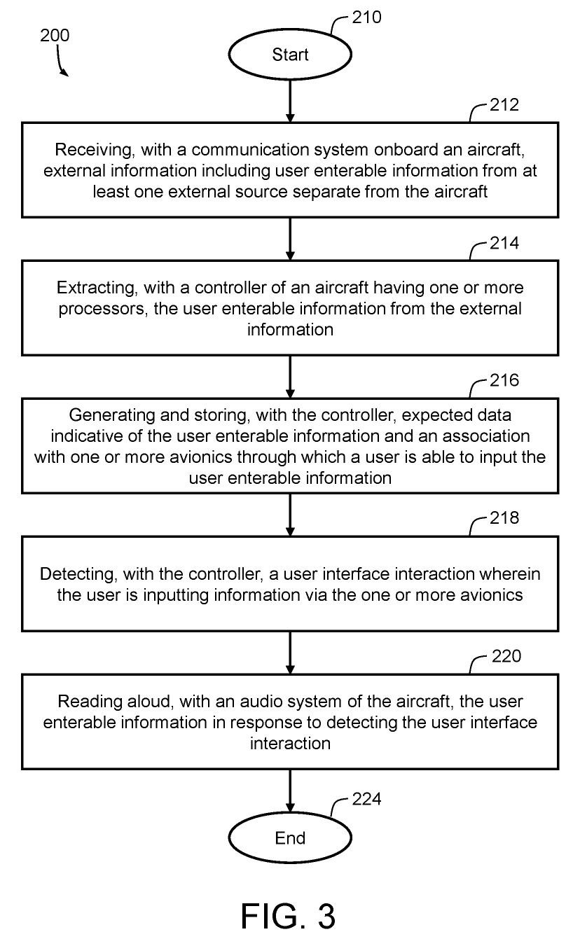

The systems disclosed herein, including the system 100, provide for methods of assisting users (e.g., pilots and/or flight crew) with data entry onboard an aircraft (e.g., the aircraft 10). For example, FIG. 3 is a flowchart illustrating an exemplary method 200 for reading out expected information while a user is inputting the corresponding information. The method 200 may start at 210.

At 212, the method 200 may include receiving, with a communication system onboard an aircraft, external information including user enterable information from at least one external source separate from the aircraft. In some examples, the user enterable information may include a clearance, a flight plan, information from service providers, etc.

At 214, the method 200 may include extracting, with one or more processors of a controller of the aircraft, the user enterable information from the external information. For example, when the external information is received in an audible message (e.g., clearance), user enterable information may be extracted by parsing the audible message, filtering the user enterable information therefrom, and generating a clip or segment of data from the audible message. In some examples, a speech-to-text conversion program may be used to transcribe the audible message prior to extraction of the user enterable information. As another example, when the external information is received as digital data including text (e.g., a filled flight plan, controller pilot data link communications (CPDLC) messages, flight planning service application messages and notifications, airliner air traffic controller (AOC) messages, dispatcher sheets, etc.), user enterable information may be extracted by using a keyword spotting program and/or a sentence segmenting program to identify the user enterable information and separate or isolate it from other information included therein.

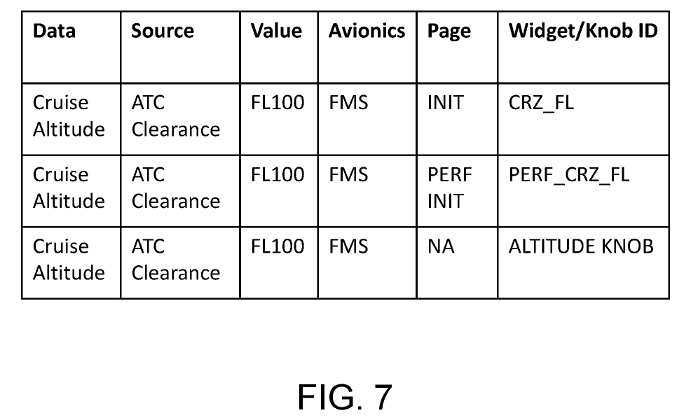

At 216, the method 200 may include generating and storing, with the controller, expected data indicative of the user enterable information and one or more avionics configured to allow a user to input the user enterable data via a user interface interaction. In various examples, the method 200 may include determining or identifying one or more avionics into which the user enterable information may be input or that is expected to be used during the user interface interaction. In such examples, the expected data may be stored in a data lookup table that includes the user enterable information and the corresponding avionics. For example, the method 200 may include determining target avionics associated with the user enterable data, and assigning a page widget ID or a knob ID data field for the target avionics. The user enterable information, the target avionics, page/widget ID and knob ID data values may be stored in, for example, a data lookup table in the database 28. FIG. 7 represents an exemplary portion of a data lookup table with entries generated and stored in response to an aircraft receiving a clearance. In this example, the clearance includes, “flight five fifty, cleared for flight level hundred, climb immediately.” In response to receiving this clearance, three table entries were generated and stored. All of the entries were stored as cruise altitude data, having a source for an ATC clearance, with an expected value of FL100 (i.e., flight level hundred), and an association with the flight management system (FMS). The first entry is further associated with an initial setup page (INIT) of the FMS and has a widget ID of CRZ_FL. The second entry is associated with a performance initialization page (PERF INIT) of the FMS and has a widget ID of PERF_CRZ_FL. The third entry is associated with a knob ID of an altitude knob.

At 218, the method 200 may include monitoring for and detecting with the controller, a user interface interaction wherein the user is inputting information via the one or more avionics.

At 220, the method 200 may include reading aloud (i.e., broadcasting), with an audio system of the aircraft, user enterable information in response to detecting the user interface interaction. Referring again to FIG. 7, the controller may monitor the various avionics of the flight systems in the aircraft, and/or the specific avionics stored in the data lookup table that include expected information. If the controller detects that a user is, for example, rotating the altitude knob, the controller may determine, based on the data lookup table, that an expected entry by the user is an altitude of flight level hundred, and an aural readout may be produced stating flight level hundred while the user is rotating the altitude knob.

In some examples, the user interface interaction may include inputting text into a text box on a graphic user interface, and the method 200 may include automatically generating the user enterable information from the expected data in the text box in response to detecting user interface interaction (e.g., selecting the text box, inputting some text into the text box, etc.). The method 200 may end at 224.

In some examples, the method 200 may include monitoring, with the controller, for turbulence during flight of the aircraft, activating, with the controller, a turbulence assistance mode in response to detecting the turbulence, and deactivating, with the controller, the turbulence assistance mode in response to detecting the turbulence has ended or has been avoided. In such examples, one or more of the steps of the method 200, such as steps 218 and 220, may be performed only while the turbulence assistance mode is active. In some examples, current turbulent conditions may be detected in real-time with one or more sensors of the sensor system 20. In some examples, information identifying regions of turbulence may be received from communications with other aircraft or ground-based systems. In some examples, regions of turbulence may be predicted using models executed by systems onboard the aircraft or by ground-based systems.

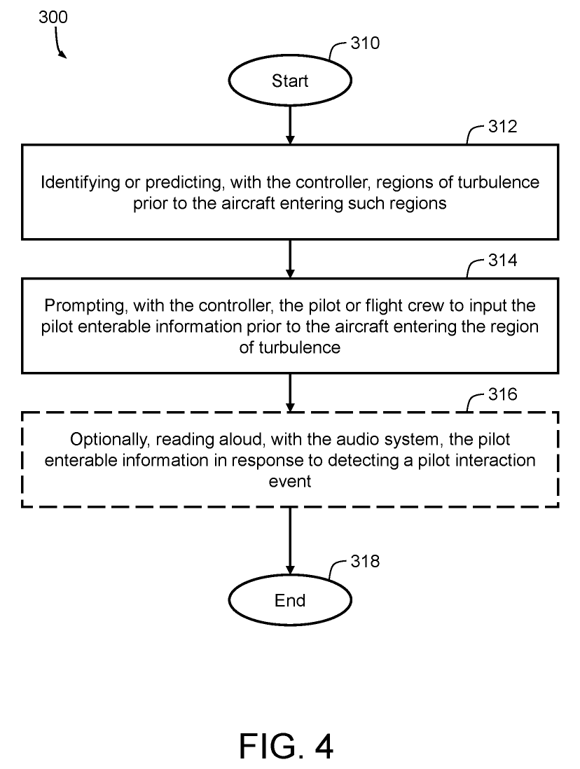

If regions of turbulence are identified or predicted prior to the aircraft entering such regions, opportunities may be available to input the user enterable information prior to experiencing turbulence. For example, FIG. 4 is a flowchart illustrating an exemplary method 300 for promoting data entry prior to turbulent conditions. The method 300 may start at 310. At 312, the method 300 may include detecting, identifying, or predicting, with the controller, a region of turbulence prior to the aircraft entering such region. At 314, the method 200 may include prompting, with the controller, the user to input the user enterable information prior to the aircraft entering the region of turbulence. In this manner, the user may be able to enter information prior to experiencing turbulence and therefore avoid data entry challenges associated therewith. At 316, the method 300 may optionally include reading aloud, with the audio system, the user enterable information in response to detecting a user interface interaction. The method 300 may end at 318.

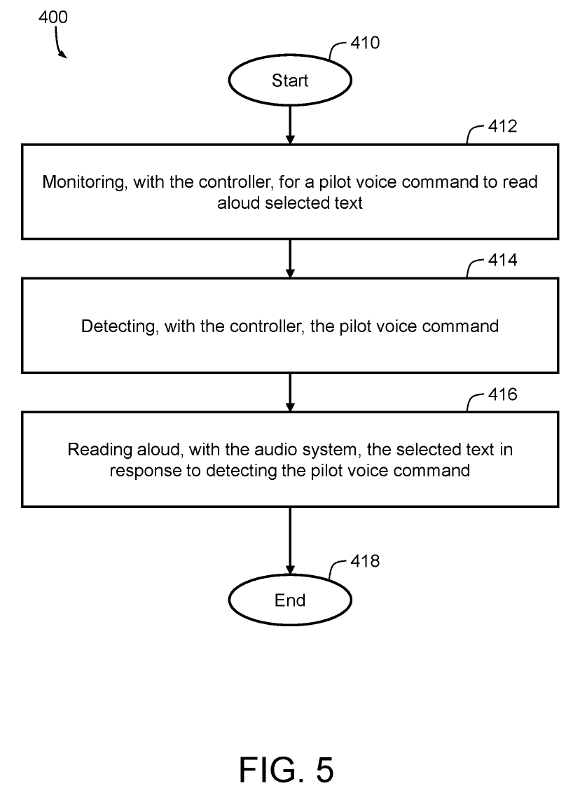

Referring now to FIG. 5, a flowchart is provided that illustrates an exemplary method 400 for reading text aloud on demand. The method 400 may start at 410. At 412, the method 400 may include monitoring, with the controller, for a user voice command to read aloud selected data. At 414, the method 400 may include receiving or detecting, with the controller, the user voice command. At 416, the method 400 may include reading aloud, with the audio system, the selected data in response to receiving or detecting the user voice command. In some examples, an entirety of the selected data may be read aloud in response to the voice command, whereas in other examples the readout may be focused to specific information. In some examples, this feature may be provided only while the turbulence assistance mode is active. The method 400 may end at 418.

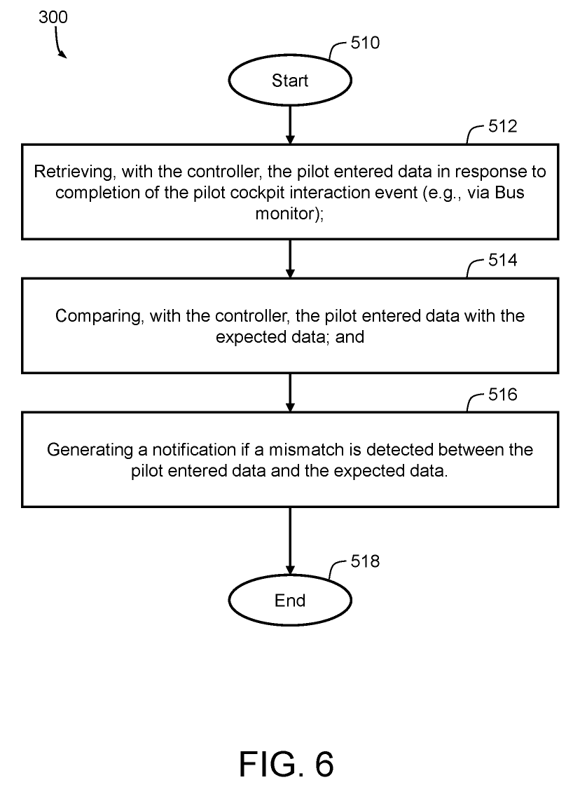

FIG. 6 is a flowchart illustrating an exemplary method 500 for cross-checking user entered information. The method 500 may start at 510. At 512, the method 500 may include retrieving, with one or more processors of a controller of an aircraft, input user entered data in response to completion of a user interface interaction (e.g., via a bus monitor), wherein the user entered data is indicative of information input by the user during the user interface interaction. At 514, the method 500 may include comparing, with the controller, the information input by the user with user enterable information stored in expected data. At 516, the method 500 may include generating a notification if a mismatch is detected between the user entered information and the user enterable information. In some examples, the notification may be an audible notification generated with the audio system (e.g., audibly reading aloud the user entered information). The method 500 may end at 518.

As another nonlimiting example, a clearance may be received by an aircraft after departure that includes the message, “climb to 12000 feet, after crossing 6000 feet, contact Phoenix North Tower at 118.7.” The user enterable information of this exemplary message, including “12000 feet” and “118.7,” may be extracted and stored as expected data. When a user begins using a corresponding avionic, such as dialing a flight control unit (FCU) knob, after crossing the altitude of 6000 feet, an aural read out of “12000 feet” may be produced. If the user subsequently enters an altitude of “1200 feet,” it may be determined that such value does not match the expected value of 12000 feet, and a notification may be generated to alert the user.

The systems and methods disclosed herein provide various benefits over certain existing systems and methods. For example, data entry during turbulence may be challenging. Pilots may have trouble reading received messages, and/or entering information into flight systems that matches or corresponds to the received messages. The systems and methods reduce a likelihood of data entry errors by reading expected information while the user is entering the information. In some examples, the systems and methods may include reading aloud text in response to a voice command from the pilot, and/or may include cross-checking entered information with the expected information to automatically detect data entry errors.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “computer-readable medium”, “processor-readable medium”, or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical. Furthermore, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements. As used herein, the term “substantially” denotes within 5% to account for manufacturing tolerances. Also, as used herein, the term “about” denotes within 5% to account for manufacturing tolerances.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A method, comprising:
receiving, with a communication system onboard an aircraft, external information including user enterable information from at least one external source separate from the aircraft;
extracting, with one or more processors of a controller of the aircraft, the user enterable information from the external information;
generating and storing, with the controller, expected data indicative of the user enterable information and an association with one or more avionics through which a user is able to input the user enterable information;
detecting, with the controller, a user interface interaction wherein the user is inputting information via the one or more avionics; and
reading aloud, with an audio system of the aircraft, the user enterable information in response to detecting the user interface interaction.

2. The method of claim 1, wherein detecting the user interface interaction and reading aloud the user enterable information in response to detecting the user interface interaction are performed while a turbulence assistance mode is active, wherein the method includes, with the controller:
monitoring for turbulence during flight of the aircraft;
activating the turbulence assistance mode in response to detecting the turbulence; and
deactivating the turbulence assistance mode in response to detecting that the turbulence has ended or has been avoided.

3. The method of claim 2, further comprising:
detecting a region of turbulence prior to the aircraft entering the region of turbulence; and
prompting, with the controller, the user to input the user enterable information via the one or more avionics prior to the aircraft entering the region of turbulence.

4. The method of claim 1, further comprising, with the controller:
retrieving the information input by the user via the one or more avionics in response to completion of the user interface interaction;
comparing the information input by the user with the user enterable information; and
generating a notification if a mismatch is detected between the information input by the user and the user enterable information.

5. The method of claim 4, wherein the notification is an audible notification produced with the audio system.

6. The method of claim 1, further comprising:
monitoring, with the controller, for a user voice command to read aloud selected data; and
reading aloud, with the audio system, the selected data in response to receiving the user voice command.

7. The method of claim 1, wherein the user interface interaction includes the user typing text into a text box on a graphic user interface, and the method includes automatically generating the user enterable information in the text box in response to detecting the user interface interaction.

8. The method of claim 1, wherein the external information is received in an audible message, and extracting the user enterable information from the external information includes parsing the audible message and filtering the user enterable information therefrom.

9. The method of claim 1, wherein the expected data is stored in a data lookup table that includes the user enterable information and the association with the one or more avionics.

10. A system onboard an aircraft, comprising:
a communication system configured to receive external information including user enterable information from at least one external source separate from the aircraft;
an audio system configured to broadcast audible messages; and
a controller in operable communication with the communication system and the audio system, the controller configured to, by one or more processors:
extract the user enterable information from the external information;
generate and store expected data indicative of the user enterable information and an association with one or more avionics through which a user is able to input the user enterable information;
detect a user interface interaction wherein the user is inputting information via the one or more avionics; and
read aloud, via the audio system, the user enterable information in response to detecting the user interface interaction.

11. The system of claim 10, wherein the controller is configured to, by the one or more processors:
monitor for turbulence during flight of the aircraft;
activate a turbulence assistance mode in response to detecting the turbulence; and
deactivate the turbulence assistance mode in response to detecting that the turbulence has ended or has been avoided,
wherein the controller is configured to detect the user interface interaction and read aloud the user enterable information only while the turbulence assistance mode is active.

12. The system of claim 11, wherein the controller is configured to, by the one or more processors:
detect a region of turbulence prior to the aircraft entering the region of turbulence; and
prompt the user to input the user enterable information via the one or more avionics prior to the aircraft entering the region of turbulence.

13. The system of claim 10, wherein the controller is configured to, by the one or more processors:
retrieve the information input by the user via the one or more avionics in response to completion of the user interface interaction;
compare the information input by the user with the user enterable information; and
generate a notification if a mismatch is detected between the information input by the user and the user enterable information.

14. The system of claim 13, wherein the notification is an audible notification produced with the audio system.

15. The system of claim 10, wherein the controller is configured to, by the one or more processors:
monitor for a user voice command to read aloud selected data; and
read aloud, with the audio system, the selected data in response to receiving the user voice command.

16. The system of claim 10, wherein the user interface interaction includes the user typing text into a text box on a graphic user interface, and the controller is configured to, by the one or more processors, automatically generate the user enterable information in the text box in response to detecting the user interface interaction.

17. The system of claim 10, wherein the external information is received in an audible message, and the controller is configured to, by the one or more processors, extract the user enterable information from the external information by, at least in part, parsing the audible message and filtering the user enterable information therefrom.

18. The system of claim 10, wherein the controller is configured to store the expected data in a data lookup table that includes the user enterable information and the association with the one or more avionics.

19. An aircraft, comprising:
a communication system configured to receive external information including user enterable information from at least one external source separate from the aircraft;
an audio system configured to broadcast audible messages; and
a controller in operable communication with the communication system and the audio system, the controller configured to, by one or more processors:
extract the user enterable information from the external information;
generate and store expected data indicative of the user enterable information and an association with one or more avionics through which a user is able to input the user enterable information;
monitor for turbulence during flight of the aircraft;
activate a turbulence assistance mode in response to detecting the turbulence; and
deactivate the turbulence assistance mode in response to detecting that the turbulence has ended or has been avoided,
wherein while the turbulence assistance mode is active the controller is configured to, by the one or more processors:
detect a user interface interaction wherein the user is inputting information via the one or more avionics; and
read aloud, via the audio system, the user enterable information in response to detecting the user interface interaction.

20. The aircraft of claim 19, wherein the controller is configured to, by the one or more processors:
retrieve the information input by the user via the one or more avionics in response to completion of the user interface interaction;
compare the information input by the user with the user enterable information; and
generate, with the audio system, an audible notification if a mismatch is detected between the information input by the user and the user enterable information.
